(19) United States
(12) Patent Application Publication
(10) Pub. No.: US 2020/0263852 A1
(43) Pub. Date: Aug. 20, 2020

(54) LAMPSHADE

(71) Applicant: TLDC (UK) Ltd, Cambridge (GB)

(72) Inventors: Scarlett Hampton, Cambridge (GB); Niki Wright, Cambridge (GB)

(73) Assignee: TLDC (UK) Ltd, Cambridge (GB)

(21) Appl. No.: 16/789,685

(22) Filed: Feb. 13, 2020

(30) Foreign Application Priority Data
Feb. 15, 2019 (GB) 1902130.2

(51) Int. Cl. F21V 1/12; F21V 17/00; F21V 17/10

(52) U.S. Cl. CPC F21V 1/12; F21V 17/105; F21V 17/002

(57) ABSTRACT

A lampshade (100) comprising a shade member, a lamp support bracket, and first and second attachment means (160, 170) comprising one or more of a magnet, hook and loop fasteners, releasable clamps, adhesive portions, and threaded fasteners, the first attachment means (160) located at a first position on the lampshade (100) arranged for releasably attaching a second lampshade (200) or the lamp support bracket (705), the second attachment means (170) located at a second position on the lampshade arranged for releasably attaching a third lampshade (300) or the lamp support bracket (705), such that, in use, two or more lampshades are connectable together, in a user-defined arrangement for attachment to a light apparatus (600), wherein the lamp support bracket (705) comprises at least one arm (715) for supporting the lampshade thereon, the lamp support bracket being arranged such that a first portion (755) of the arm is moveable relative to a second portion (765) of the arm in a rotational, translational, and/or telescopic manner, in order to adjust the size of the at least one arm.

### CROSS-REFERENCE TO RELATED APPLICATIONS

The present application claims priority under 35 U.S.C. § 119 to United Kingdom patent application GB 1902130.2 filed on Feb. 15, 2019 in the United Kingdom Intellectual Property Office, the entire disclosure of which is incorporated herein by reference.

### BACKGROUND

### 1. Field

The present invention relates generally to a lampshade and finds particular, although not exclusive, utility in providing a lampshade that is connectable to another lampshade in a user-defined arrangement to provide a larger lampshade.

### 2. Description of the Related Art

A lamp is conventionally used to illuminate a room. A lampshade is conventionally used to diffuse the light produced by the lamp so that the light is less harsh and therefore more comfortable. A lampshade may be used with a ceiling mounted pendant lamp, a table or floor mounted lamp, or a wall mounted lamp. Typically, a lampshade includes a shade, a wire frame to stiffen and support the shade, and an integral bracket attached to the frame, so that the bracket can be used to attach the shade to the lamp. The bracket of a lampshade typically includes an annulus that is clamped between two parts of the lamp. Some lampshades do not have a frame, as the shade is metal, glass, or some other material that is strong enough to support itself without need of a frame, although a bracket is usually still required. Lampshades are typically shaped, sized, and decorated to provide a desired aesthetic or design. However, design is a personal choice and it is not always possible to find a lampshade that has the desired shape, so some degree of customization is preferable.

### SUMMARY

In a first aspect, the present invention provides a lampshade comprising a shade member and first and second attachment means, the first attachment means located at a first position on the lampshade arranged for releasably attaching a second lampshade or a support bracket, the second attachment means located at a second position on the lampshade arranged for releasably attaching a third lampshade or a support bracket, such that, in use, two or more lampshades are connectable together, in a user-defined arrangement for attachment to a light apparatus.

In this way, the lampshade may be attached to other similar lampshades, via the attachment means, in a user-defined arrangement to provide a larger lampshade with a different shape. Each shade may also comprise differently coloured or patterned material to create a different effect. The lampshade allows greater freedom of design choice for the end user, as the end user can also change the arrangement of lampshades.

The user may stack lampshades to form a larger lampshade, having a customised design. The user may stack three lampshades. For example, an existing cylindrical lampshade may have a frustoconical lampshade attached to the top of it, with another cylindrical lampshade attached to the top of the frustoconical lampshade.

The lampshade may have any shape. For example, the lampshade may be cylindrical or frustoconical. The shade member may be supported on or by a frame, which may be or have any shape or construction, such as two parallel wire hoops connected together by linear rods. The shade may comprise a solid material, or it may have perforations. The shade member may comprise a translucent, transparent, light-diffusing, opaque, a non-transparent material, or any combination of said materials.

The lampshade may comprise at least two apertures. The at least two apertures may be at the top and the bottom of the lampshade, as is conventional. The apertures may be defined by the shade member. The attachment means may be arranged to attach the lampshade to the second and/or third lampshade(s) such that one of the apertures coincides with an aperture of the second and/or third lampshade(s). Connecting a second lampshade to the lampshade in this way may mean that the shade member of the second lampshade begins at the point where the shade member of the lampshade terminates. Therefore, the shade member of the second lampshade may be considered to be an extension of the shade member of the lampshade. The second and/or third lampshade(s) may be lampshades according to the first aspect of the present invention. The lampshade may have more than two apertures. For instance, the lampshade may be substantially Y-shaped and comprise three apertures, with one aperture located at an end of each of the three arms of the Y.

The lampshade may further comprise a first rim around one of the at least two apertures. The first rim may be part of a frame. The first rim may have the same size and shape as the perimeter of the aperture. The first rim may define the perimeter of the aperture and frame, encircle, and/or bound the aperture. The first rim may reinforce the lampshade in the region of the aperture. For example, the first rim may comprise a steel wire that encircles the aperture.

The lampshade may further comprise a second rim around a second of the at least two apertures. The second rim may also be part of a frame. The frame may further comprise rods or other structures to connect the first rim to the second rim.

The first and second attachment means may be distributed around the first and second rims respectively. The first and/or second attachment means may comprise one or more discrete attachment portions. The attachment portions may be distributed evenly and/or uniformly around the rim. For example, an attachment portion may be provided at each corner of a square rim. Alternatively, the portions may be distributed around the rim in an uneven manner. For example, the attachment portions may be distributed along one half of the rim only.

The first and/or second rim(s) may comprise recessed portions. The recessed portions may be depressions into a surface of the first and/or second rim(s). The first and second attachment means may be positioned in the recessed portions of the first and second rims respectively. Alternatively, and/or additionally, the first and second attachment means may be positioned in the recessed portions of the second and first rims respectively. Recessing the attachment means into the first and second rims means that a rim of a first lampshade, in use, may abut a rim of a second lampshade without a gap therebetween, and also look neater. Alternatively, the first and second attachment means may be positioned away from the first and second rims. For example, the attachment means may be positioned on the shade half way between the two ends of a frustoconical lampshade such that a cylindrical lampshade, having a radius between the radii of the two ends of the frustoconical lampshade, may be attached to an inside or outside surface of the frustoconical lampshade.

One or both of the first and second attachment means may comprise a magnet, hook and loop fasteners, Dual Lock (RTM) fasteners, releasable clamps, adhesive portions, and/or threaded fasteners. Other attachments are contemplated. The use of magnets may allow the lampshade to be attachable to another lampshade by simply placing it adjacent to the other lampshade. Furthermore, magnets may allow the lampshade to be detached from another lampshade by simply pulling it away from the other lampshade. If magnets are used in the attachment means, and a user would like to change the arrangement of lampshades, they may simply and quickly pull the lampshades apart and change their order, without the need for tools. The magnets may each have a magnetic pull strength of between 0.01 kg and 0.5 kg. Other magnetic pull strengths are contemplated. In this way, the magnets may be strong enough to suspend or support one or more lampshades. Relatively strong magnets may allow a user to create a lampshade arrangement comprising a large number of lampshades, or relatively heavy lampshades. For example, the user may wish to have an arrangement of 5 lampshades hanging from a ceiling mounted lamp, which means that the weight of up to five lampshades may need to be suspended from a single attachment means.

The lampshade may further comprise a magnetic material. For example, a rim or frame may be iron or steel. Alternatively, and/or additionally, the shade member may comprise magnetic material, and may be steel. A magnetic rim, frame, or shade member means that another lampshade, comprising magnets, may be attached to the rim, frame, or shade member.

The first rim may comprise a curved portion. For example, the first rim may be circular or elliptical. The magnets may have a curvature that matches the curvature of the curved portion. The magnets may have a constant radius of curvature. For example, the first rim may be circular with a radius of 250 mm, and the magnets may be arcuate with a constant radius of curvature of 250 mm. Alternatively, the magnets may have a non-constant radius of curvature. For example, the magnets may be curved to match an elliptical first rim.

The first and second attachment means may comprise the same type of fastener. Alternatively, and/or additionally, the first and second attachment means may comprise different types of fastener. The first and/or second attachment means may be of a type suitable for attaching the lampshade to another lampshade or a lamp attachment bracket placed adjacent to the first and/or second attachment means. For example, the first attachment means may comprise magnets, so that the first attachment means may be used to attach the lampshade to a steel lamp support bracket, and the second attachment means may comprise hook and look fasteners, to allow the lampshade to be attached to another lampshade also having hook and loop fasteners.

The lampshade may further comprise a lamp support bracket for attaching the lampshade to a lamp. In this regard, the term ‘lamp’ may mean a pendant light apparatus, or a table lamp base. The lamp support bracket may comprise a lamp attachment piece, such as an annulus, that is clamped between two parts of the lamp, or any other known structure. In this way, the lamp support bracket may be attachable to a lamp, such as a table lamp or a ceiling mounted pendant lamp. The lamp support bracket may be releasably attachable to one of the first and second attachment means. Alternatively, the lamp support bracket may be integral with the lampshade. The lamp support bracket may comprise adjustment means for adjusting the size of the bracket such that the bracket is attachable to a range of other lampshades each having a different size. In this way, a single lamp support bracket may be usable with a range of lampshades, wherein the range of lampshades may comprise differently sized lampshades. For example, when using the lamp support bracket to suspend a lampshade, the lampshade may be replaced with another lampshade of a different size without needing to replace the lamp support bracket.

The lamp support bracket may comprise at least one arm for supporting the lampshade thereon. The arm may comprise any number of arm portions, for example two arm portions or three arm portions. The arm portions may be connected end to end to form a substantially linear arrangement. The adjustment means may be arranged such that a first portion of the arm may be moveable relative to a second portion of the arm, and may be moveable relative to the lamp attachment piece, in a rotational, translational, and/or telescopic manner. Other arm portions may be moveable relative to each other in a similar manner. Adjacent arm portions may be attached via a hinge or a rail. One arm portion may be received within an adjacent arm portion to allow telescopic movement. The arm portions may be moveable to alter the length of the arm. For example, the arm may be arranged to support a lampshade having a radius of approximately 225 mm, and, after moving one or more of the arm portions to alter the length of the arm, the arm may be arranged to support a lampshade having a radius of approximately 125 mm. The arm may be incrementally adjustable such that the lamp support bracket is arrangeable to support a lampshade having a radius in the range of 120 mm to 230 mm. Alternatively, the range may be 100 mm to 250 mm, 75 mm to 275 mm, 50 mm to 300 mm, 30 mm to 500 mm, or any subset of these ranges. Other dimensions and ranges are contemplated.

The lampshade may be provided without an integral lampshade bracket. In this way, the lampshade may be attached to another lampshade, already having a lampshade bracket, to provide a more visually pleasing and cost-effective lampshade. For example, a first lampshade may be attached to a light apparatus via a bracket, and a second lampshade, without an integral bracket, may be attached to the first lampshade. Therefore, two lampshades would be suspended from or supported by the bracket of the first lampshade, and there would not be a second, redundant, bracket to detract from the aesthetics of the arrangement.

The lamp support bracket may comprise attachment means at the end of each arm, of the same type as the first and/or second attachment means, to allow the arms to be attached to the lampshade. The attachment means at the end of each arm may be attachable to the first and/or second attachment means, the first and/or second rims, the frame, and/or the shade member. For example, the first attachment means may comprise magnets, and the lamp support bracket may have a magnet at the end of some, or all, of the arms, to attach to the magnets of the first or second attachment means or to a portion of a rim without magnets.

The perimeter of a first of the at least two apertures may have any shape, for example a circle or a rectangle. A perimeter of a second of the at least two apertures may have the same shape and size as the perimeter of the first of the at least two apertures or a different shape and/or size from the perimeter of the first of the at least two apertures. The size and shape of the perimeters may form part of the design of the lampshade and may be chosen to provide the desired look, or to allow the lampshade to be attached to another lampshade. For example, the lampshade may have a star-shaped aperture and a circular aperture, so that, in use, the star-shaped aperture casts an interesting shadow whilst the circular aperture allows the lampshade to be attached to a cylindrical lampshade.

The lampshade may further comprise a cover for attaching thereto, and for and covering at least a portion of one of the at least two apertures. In this way, two lampshades with differently sized apertures may be attached without leaving some of the larger aperture exposed. The cover may be substantially planar. The cover may comprise a first cover rim that has the same size and shape as the perimeter of one of the at least two apertures. The cover may comprise a second cover rim that has a different size and/or shape from the first cover rim. The cover may have the shape of an annulus. The first cover rim and the second cover rim may be concentric circles lying in the same plane as one another. The cover may be used to provide a continuous shade member when two differently sized lampshades are attached. For example, if a cylindrical shade with a radius of 250 mm is to be attached to another cylindrical shade with a radius of 125 mm, the cover may be used to cover the gap between the rims of the two differently sized lampshades. The cover may be considered an adapter, as one function it performs is to adapt the lampshade to allow it to attach to another lampshade of a different size.

The cover may comprise a light-diffusing material. Alternatively, and/or additionally, the cover may comprise a translucent, transparent, opaque and/or non-transparent material. The cover may comprise a solid material. Alternatively, and/or additionally, the cover may comprise a material with perforations, holes, cuts, slits, and/or any other known opening. The cover may be arranged to match the shade member. The cover may comprise the same material as the shade member. For example, the shade members of two lampshades and the cover may both comprise blue linen so that, when the three components are attached, the resulting lampshade looks to be a single piece. The cover may be an extension of the shade member.

The first and second cover rims may comprise first cover rim attachment means and second cover rim attachment means respectively for attaching the cover to the lampshade via the first or second attachment means. The first and second cover rim attachment means may be of the same type as the first or second attachment means. For example, any of the first and second attachment means and the first and second cover rim attachment means may comprise magnets, comprise a mixture of magnets and portions of magnetic material for being held by the magnets, or may comprise magnetic material without magnets.

The lampshade may also be provided with a tab arranged to be gripped by a user when detaching the lampshade from another lampshade or bracket. A tab may be positioned on the first rim and/or second rim. The tab may be a flexible material such as linen, or it may be a stiff material such as a plastic or steel. When detaching two lampshades, the user may grip the tabs rather than the shade members or rims, so as to avoid causing damage to the lampshade.

The first rim, second rim, first cover rim, and/or second cover rim may have a U-shaped cross-section. The U-shaped cross-section may comprise two parallel webs and a third web therebetween. The third web may be perpendicular to the two parallel webs. The U-shaped cross-section may define a channel. The first attachment means, second attachment means, first cover rim attachment means, and/or second cover rim attachment means may be positioned within the channel.

In a second aspect, the present invention provides a modular lampshade system comprising two or more lampshades according to the first aspect. In this regard, a rim of the first and a rim of the second lampshades may be circular. The rim of the first lampshade may have a larger diameter than the rim of the second lampshade. The lampshade system may comprise a cover according to the first aspect. A first cover rim may have the same diameter as the rim of the first lampshade. A second cover rim may have the same diameter as the rim of the second lampshade. Light-diffusing material may be positioned between the two cover rims. The modular lampshade system may be arrangeable such that the first cover rim is attachable to the rim of the first lampshade with the first attachment means of the first lampshade and the second cover rim is attachable to the rim of the second lampshade with the first attachment means of the second lampshade to form a single lampshade.

In a third aspect, the present invention provides a lampshade bracket for releasably attaching a lampshade to a lamp support, wherein the bracket comprises adjustment means for adjusting the size of the bracket such that the bracket fits a range of lampshades each having a different size. In this way, a single lamp support bracket may be usable with a range of lampshades, wherein the range of lampshades may comprise differently sized lampshades. For example, when using the lamp support bracket to suspend a lampshade, the lampshade may be replaced with another lampshade of a different size without needing to replace the lamp support bracket.

The lamp support bracket may comprise a lamp attachment piece, such as an annulus, that is clamped between two parts of the lamp, or any other known structure. In this way, the lamp support bracket may be attachable to a lamp, such as a table lamp or a ceiling mounted pendant lamp. The lamp support bracket may be releasably attachable to one of the first and second attachment means.

The lamp support bracket may comprise at least one arm for supporting the lampshade thereon. The arm may comprise any number of arm portions, for example two arm portions or three arm portions. The arm portions may be connected end to end to form a substantially linear arrangement. The adjustment means may be arranged such that a first portion of the arm may be moveable relative to a second portion of the arm, and may be moveable relative to the lamp attachment piece, in a rotational, translational, and/or telescopic manner. Other arm portions may be moveable relative to each other in a similar manner. Adjacent arm portions may be attached via a hinge or a rail. One arm portion may be received within an adjacent arm portion to allow telescopic movement. The arm portions may be moveable to alter the length of the arm. For example, the arm may be arranged to support a lampshade having a radius of approximately 225 mm, and, after moving one or more of the arm portions to alter the length of the arm, the arm may be arranged to support a lampshade having a radius of approximately 125 mm. The arm may be incrementally adjustable such that the lamp support bracket is arrangeable to support a lampshade having a radius in the range of 120 mm to 230 mm. Alternatively, the range may be 100 mm to 250 mm, 75 mm to 275 mm, 50 mm to 300 mm, 30 mm to 500 mm, or any subset of these ranges. Other dimensions and ranges are contemplated.

The lamp support bracket may comprise attachment means at the end of each arm, of the same type as the first and/or second attachment means, to allow the arms to be attached to the lampshade. The attachment means at the end of each arm may be attachable to the first and/or second attachment means, the first and/or second rims, the frame, and/or the shade member.

Magnetic material may be material that is susceptible to attraction to a magnet, for example iron or nickel, but which is not magnetic itself.

The magnets of the first or second attachment means may be arranged such that the north pole of each magnet faces outwardly from the lampshade. Alternatively, all the south poles may face outwardly. It is also possible that any lampshade may include a mixture of magnets, some having their north poles facing outwardly and some having their south poles facing outwardly. It is also possible for a lampshade to have all north poles facing outwardly in the first attachment means and all south poles facing outwardly in the second attachment means.

### BRIEF DESCRIPTION OF THE DRAWINGS

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1 is a schematic view of a lampshade arrangement including four lampshades.

FIG. 2 is a plan view of a first lampshade.

FIG. 3 is a perspective view of a portion of a rim.

FIG. 4 is a perspective view of a cover.

FIG. 5 is a plan view of a lamp support bracket.

FIG. 6 is a side view of the lamp support bracket shown in FIG. 5.

### DETAILED DESCRIPTION

The present invention will be described with respect to certain drawings but the invention is not limited thereto but only by the claims. The drawings described are only schematic and are non-limiting. Each drawing may not include all of the features of the invention and therefore should not necessarily be considered to be an embodiment of the invention. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that operation is capable in other sequences than described or illustrated herein. Likewise, method steps described or claimed in a particular sequence may be understood to operate in a different sequence.

Moreover, the terms top, bottom, over, under and the like in the description and the claims are used for descriptive purposes and not necessarily for describing relative positions. It is to be understood that the terms so used are interchangeable under appropriate circumstances and that operation is capable in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “an embodiment” or “an aspect” means that a particular feature, structure or characteristic described in connection with the embodiment or aspect is included in at least one embodiment or aspect of the present invention. Thus, appearances of the phrases “in one embodiment”, “in an embodiment”, or “in an aspect” in various places throughout this specification are not necessarily all referring to the same embodiment or aspect, but may refer to different embodiments or aspects. Furthermore, the particular features, structures or characteristics of any one embodiment or aspect of the invention may be combined in any suitable manner with any other particular feature, structure or characteristic of another embodiment or aspect of the invention, as would be apparent to one of ordinary skill in the art from this disclosure, in one or more embodiments or aspects.

Similarly, it should be appreciated that in the description various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Moreover, the description of any individual drawing or aspect should not necessarily be considered to be an embodiment of the invention. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the terms “at least one” and “at least two” may mean only one and only two respectively in certain circumstances. The use of the term “any” may mean “all” and/or “each” in certain circumstances.

The principles of the invention will now be described by a detailed description of at least one drawing relating to exemplary features. It is clear that other arrangements can be configured according to the knowledge of persons skilled in the art without departing from the underlying concept or technical teaching, the invention being limited only by the terms of the appended claims.

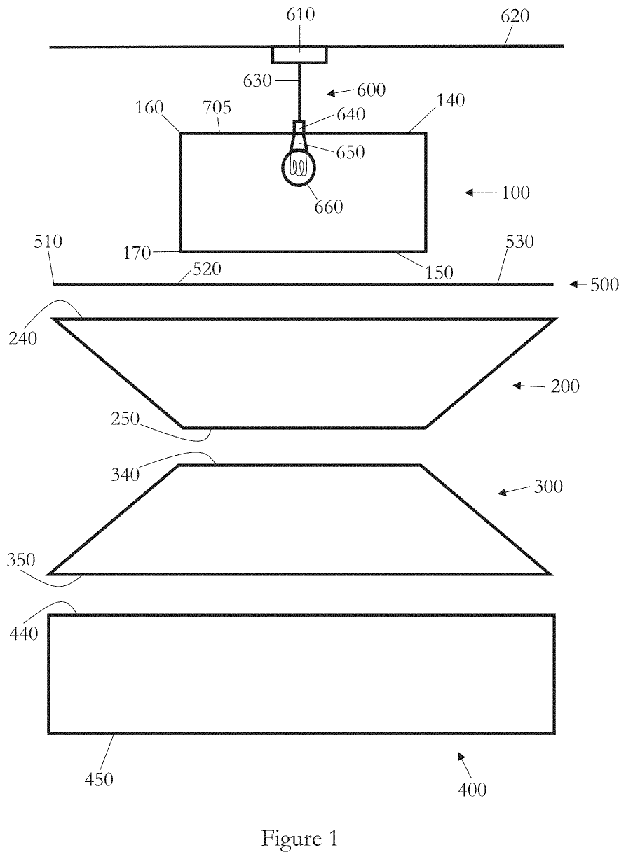

FIG. 1 is a schematic view of a lampshade arrangement including the four lampshades 100, 200, 300, 400, and a cover 500. The parts are shown separated for clarity. However, in use, the various parts would lie immediately adjacent one another. The first lampshade 100 is substantially cylindrical with open ends. The upper open end is framed by a first circular rim 140 and the lower open end is framed by a second circular rim 150. Each of the rims 140, 150 have a substantially rectangular cross-section, and have a radius of approximately 125 mm. The plane in which the first rim 140 lies is substantially parallel to the plane in which the second rim 150 lies, and is spaced from the second rim 150 by approximately 100 mm. Four attachment means (which may be magnets) 160 are evenly spaced around the first rim 140. The magnets 160 are approximately 50 mm long, 6 mm wide, and 3 mm high, and are curved with a radius of curvature of approximately 125 mm to match the curvature of the first rim 140. The magnets 160 are recessed downwardly into an upper surface of the first rim 140. Four magnets 170, similarly sized and shaped to the other magnets 160, are also evenly spaced around the second rim 150 is a similar manner to the magnets 160 on the first rim 140. The magnets 170 are recessed upwardly into a lower surface of the second rim 150.

The second lampshade 200 is substantially frustoconical with open ends. The upper open end is larger than the lower open end. The upper open end is framed by a first circular rim 240. The lower open end is framed by a second circular rim 250. Each of the rims 240, 250 has a substantially rectangular cross-section. The first rim 240 has a radius of approximately 250 mm, and the second rim 250 has a radius of approximately 125 mm. The plane in which the first rim 240 lies is substantially parallel to the plane in which the second rim 250 lies, and is spaced from the second rim 250 by approximately 325 mm. Eight magnets are evenly spaced around the first rim 240, and the magnets have a curvature with a radius of 250 mm to match the first rim 240. Four magnets are evenly spaced around the second rim 250, and the magnets have a curvature with a radius of 125 mm to match the second rim 240. Each of the magnets are approximately 50 mm long, 6 mm wide, and 3 mm high. The magnets are recessed upwardly and downwardly into their respective rims in a similar manner to the magnets of the first lampshade 100.

The third lampshade 300 is similar to the second lampshade 200 in size and shape, but is oriented upside down such that its smaller rim 340 is above its larger rim 350. The fourth lampshade 400 is similar to the first lampshade 100 but has rims with radii of 250 mm.

The cover 500 has the shape of a substantially planar annulus. The cover 500 includes an outer ring 510 and an inner ring 520. The outer ring 510 has a radius of approximately 250 mm, and the inner ring 520 has a radius of approximately 125 mm. The outer ring 510 and the inner ring 520 are concentric and lie in the same plane as one another. A continuous piece of light-diffusing material 530 is positioned between the outer 510 and inner 520 rims. Each of the two rims 510, 520 are steel, which means that the cover 500 is attachable to a lampshade via the magnets on the lampshade.

The first lampshade 100 is attached to a pendant light apparatus 600 with a lamp support bracket 705. The light apparatus 600 comprises a ceiling rose 610 attached to a ceiling 620. An electric cable 630 depends from the ceiling rose 610. A light bulb socket 640 is provided on the end of the cable 630 distal from the ceiling rose 610. A light bulb 660 is positioned in the light bulb socket 640. A thread is provided on an exterior surface of the light bulb socket 640, and a clamping piece 650, with a corresponding thread on an interior surface thereof, is mounted on the light bulb socket 640. The lamp support bracket 705 includes an annulus that is positioned between the light bulb socket 640 and the clamping piece 650. In this way, the lamp support bracket 705 is suspended from the ceiling 620. The lamp support bracket 705 comprises three arms which extend away from the annulus and therefore away from the light bulb socket 640. The lamp support bracket 705 is steel and the ends of the arms opposing the ends attached to the annulus are connected to the integral magnets on the upper rim 140 of the first lampshade 100, such that the first lampshade is suspended therefrom. The light bulb socket 640 and light bulb 660 are located within an interior of the first lampshade 100.

The inner rim 520 of the cover 500 is magnetically attached to the lower rim 150 of the first lampshade 100, such that the cover 500 is suspended from the first lampshade 100. The upper rim 240 of the second lampshade 200 is magnetically attached to the outer rim 510 of the cover, such that the second lampshade 200 is suspended from the cover 500. The upper rim 340 of the third lampshade 300 is magnetically attached to the lower rim 250 of the second lampshade 200, such that the third lampshade 300 is suspended from the second lampshade 200. The upper rim 440 of the fourth lampshade 400 is magnetically attached to the lower rim 350 of the third lampshade 300, such that the fourth lampshade 400 is suspended from the third lampshade 300. The light from light bulb 660 is able to pass through the aperture bounded by the upper rim 140 of the first lampshade 100 and illuminate the ceiling 620. The light from light bulb 660 is also able to pass through each of the lampshades 100, 200, 300, 400 and exit through the aperture bounded by the lower rim 450 of the fourth lampshade 400. Furthermore, the light from light bulb 660 is able to pass through each of the lampshades 100, 200, 300, 400.

Further lampshades may be attached to the lower rim 450 of the fourth lampshade 400. It is possible to rearrange the order of the lampshades 100, 200, 300, 400, as well as remove or replace one or more of the lampshades. If two rims of differing size and/or shape are to be connected, a cover 500, having appropriately sized and shaped first and second cover rims, may be positioned between the two rims.

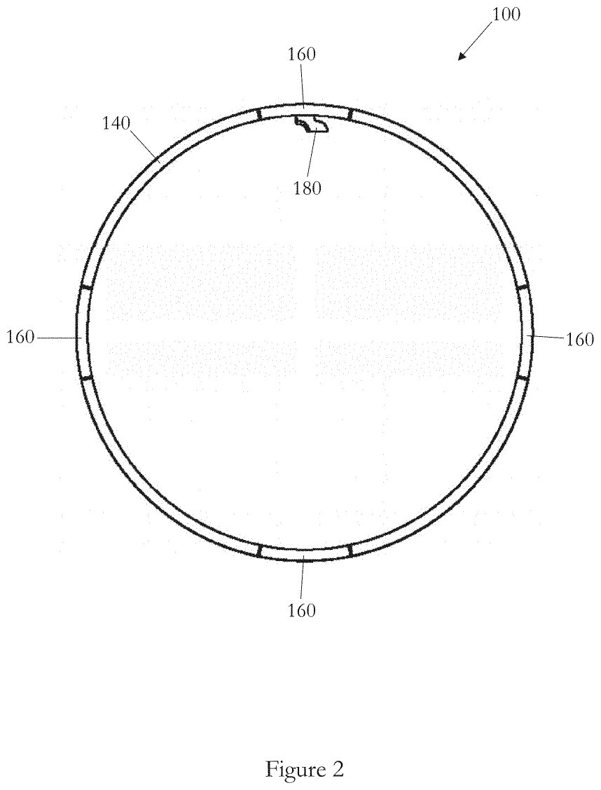

FIG. 2 is a plan view of the lampshade 100 shown in FIG. 1. The magnets 160 are recessed downwardly into the surface of the rim 140 and have a width substantially equal to the width of the rim 140. A tab 180 extends radially inwardly from the first rim 140, and may be gripped by the user when separating two lampshades.

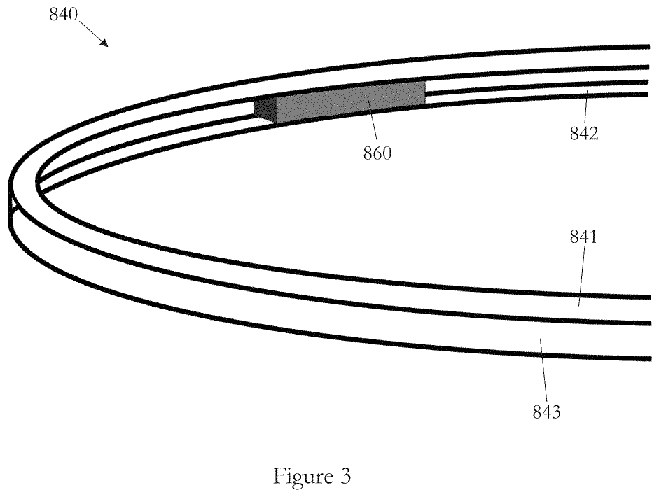

FIG. 3 is a perspective view of a portion of a rim 840. The rim 840 is substantially circular and has a U-shaped cross-section. The U-shaped cross-section includes three substantially planar webs 841, 842, 843. Two of the webs 841, 842 are parallel and of equal length. The third web 843 is perpendicular to each of the two parallel webs 841, 842 and connects an end of the parallel webs 841, 842. The third web 843 is longer than the two parallel webs 841, 842. The rim 840 is arranged such that the open side of the U-shaped cross-section is on an interior side of the rim. A magnet 860 is positioned within the U-shaped rim 840. The magnet 860 is arcuate with a radius of curvature that matches the radius of the substantially circular rim 840. The magnet 860 is sized and shaped to fit entirely within the U-shaped rim 840 and to contact each of the three webs 841, 842, 843 of the rim 840.

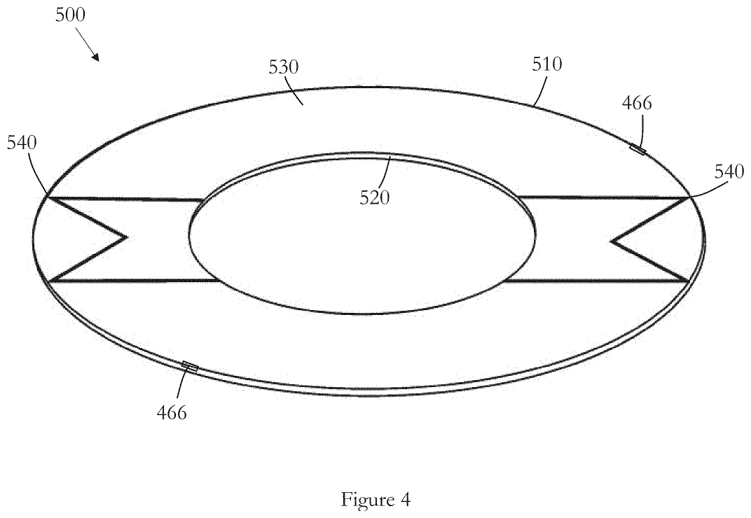

FIG. 4 is a perspective view of the cover 500 shown in FIG. 1. The light-diffusing material 530 is continuous and is positioned between the outer 510 and inner 520 circular rims. Two M-shaped frames 540 are used to connect the outer rim 510 to the inner rim 520, and are positioned between the two rims 510, 520. Other means of connecting the two cover rims 510, 520 together are contemplated. It is also possible that no connections are provided other than the light-diffusing material 530. The M-shaped frames 540 lie in the same plane as the rims 510, 520 and the light-diffusing material 530. The two parallel webs of each M-shaped frame 540 extend between the outer 510 and inner 520 rims. The cover includes cover attachment means 466.

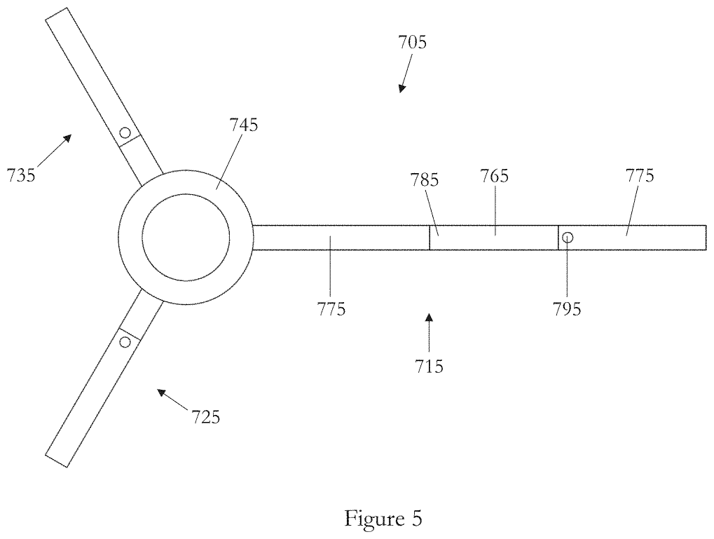

FIG. 5 is a plan view of the lamp support bracket 705, which has three substantially identical arms 715, 725, and 735 equally spaced around the annulus 745 which is suitable for attachment to the light apparatus as described in relation to FIG. 1. The annulus 745 has an outer radius of approximately 65 mm and an inner radius of approximately 42 mm. Only a first arm 715 will be described, but the description of the first arm 715 is considered to also be a description of the other arms 725, 735, as they may be similar to the first arm 715. The arm 715 comprises a first portion 755, a second portion 765, and a third portion 775. Each of the three portions 755, 765, 775 have the same rectangular cross-section with a width of approximately 12 mm and a height of approximately 3 mm. The first portion 755 is attached at a first end thereof to the annulus 745. The second portion 765 is attached to the end of the first portion 755 that is distal to the annulus 745 via a first rotational hinge 785. The third portion 775 is attached to the end of the second portion 765 that is distal to the first portion 755 via a second rotational hinge 795. The first portion 755 may also be rotatably attached to the annulus 745. The end of the first portion 755 distal to the annulus 745 is approximately 125 mm from the centre of the annulus 745, measured in a radial direction. The second portion 765 and third portion 775 are substantially equal in length and are approximately 70 mm long. The first hinge 785 is arranged such that the second portion 765 rotates about an axis normal to the plane in which the second portion 765 lies. The second hinge 795 is arranged such that the third portion 775 rotates about an axis normal to the plane in which the third portion 775 lies. The second portion 765 and third portion 775 may be arranged in any rotational orientation between a stowed position, in which arms 735 and 745 are shown, and an extended position, in which arm 715 is shown. In the stowed position, a lampshade with a radius of approximately 125 mm may be supported on the bracket 705 adjacent to the first hinge 785. In the extended position, a lampshade with a radius of approximately 250 mm may be supported on the bracket 705 adjacent to the end of the third portion 775 distal to the second hinge 795. The bracket 705 may be used to support a lampshade with a radius more than 125 mm and less than 250 mm thereon by orienting the second portion 765 and the third portion 775 accordingly.

Although not shown, the first portion 755 may be moveable relative to the annulus 745 such as by the provision of a hinge, a pivot, or some other joint.

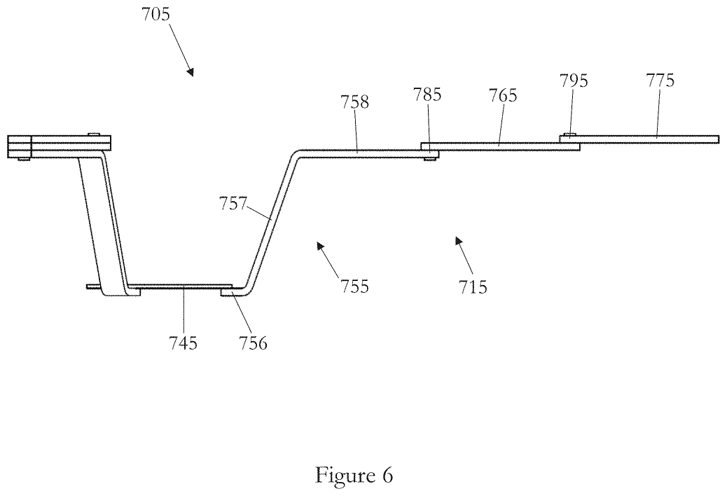

FIG. 6 is a side view of the bracket 705. The annulus 745 has a thickness of approximately 1.5 mm. The first portion 755 comprises a lower web 756, an inclined web 757 and an upper web 758. The lower web 756 is attached to the annulus 745 and overlaps the annulus 745. The lower web 756 extends away from the annulus 745 in a plane that is parallel to a plane of the annulus 745. The inclined web 757 of the first portion 755 extends from the lower web at an angle of approximately 80°. The upper web 758 of the first portion 755 extends from the inclined web, away from the annulus 745, in a plane that is parallel to the plane of the annulus 745 and the plane of the lower web 756. The second portion 765 is substantially planar and lies in a plane that is parallel to and above the plane of the upper web 758 of the first portion 755. The second portion 765 is moveable between the extended position as shown, where it extends away from the upper web 758, and the stowed position in which it abuts against the upper web 758 along the entire length of the upper web 758. The third portion 775 is substantially planar and lies in a plane that is parallel to and above the plane of the second portion 765. The third portion 775 is moveable between the extended position as shown, where it extends away from the second portion 765, and the stowed position in which it abuts against the second portion 765 along its entire length. The adjacent portions of the arm 715 overlap each other by approximately 9 mm, and the joints 785, 795 comprise pins through the overlapping portions of the arm 715. The lower web 756 may be rotatably attached to the annulus.

It will be seen how the arms 715, 725, 735, are arranged to lie in the same plane which is parallel to, but out of, the plane in which the annulus 745 lies.

1. A lampshade comprising a shade member, a lamp support bracket, and first and second attachment means comprising one or more of a magnet, hook and loop fasteners, releasable clamps, adhesive portions, and threaded fasteners, the first attachment means located at a first position on the lampshade arranged for releasably attaching a second lampshade or the lamp support bracket, the second attachment means located at a second position on the lampshade arranged for releasably attaching a third lampshade or the lamp support bracket, such that, in use, two or more lampshades are connectable together, in a user-defined arrangement for attachment to a light apparatus, wherein the lamp support bracket comprises at least one arm for supporting the lampshade thereon, the lamp support bracket being arranged such that a first portion of the arm is moveable relative to a second portion of the arm in a rotational, translational, and/or telescopic manner, in order to adjust the size of the at least one arm.

2. The lampshade of claim 1, wherein the lampshade is provided without an integral lampshade bracket.

3. The lampshade of claim 1, wherein the magnets each have a magnetic pull strength of between 0.01 kg and 0.5 kg.

4. The lampshade of claim 1, further comprising at least two apertures in the shade member, wherein a perimeter of a first of the at least two apertures has the same shape and size as the perimeter of a second of the at least two apertures.

5. The lampshade of claim 1, further comprising at least two apertures in the shade member, wherein a perimeter of a first of the at least two apertures has a different shape and/or size from the perimeter of a second of the at least two apertures.

6. The lampshade of claim 5, wherein the first attachment means is adjacent the first aperture, and the second attachment means is adjacent the second aperture.

7. The lampshade of claim 1, further comprising a first rim around one of at least two apertures in the shade member.

8. The lampshade of claim 7, wherein the first rim comprises a curved portion and the first attachment means have a curvature that matches the curvature of the curved portion.

9. The lampshade of claim 8, wherein the first attachment means are distributed around the first rim.

10. The lampshade of claim 7, further comprising a second rim around a second of the at least two apertures, wherein the second attachment means are distributed around the second rim.

11. The lampshade of claim 9, wherein the first rim comprises recessed portions and the first attachment means are positioned in the recessed portions.

12. The lampshade of claim 6, further comprising a substantially planar cover for attaching thereto, and for covering at least a portion of one of the at least two apertures, wherein the cover comprises a first cover rim that has the same size and shape as the perimeter of one of the at least two apertures, a second cover rim that has a different size and/or shape from the first cover rim, and a light-diffusing material between the first and second cover rims.

13. The lampshade of claim 12, wherein the first cover rim comprises first cover rim attachment means for attaching the cover to the lampshade via the first or second attachment means, and the second cover rim comprises second cover rim attachment means for attaching the cover to another lampshade via other first or second attachment means, wherein the first and second cover rim attachment means comprises one or more of a magnet, hook and loop fasteners, releasable clamps, adhesive portions, and threaded fasteners.

14. A modular lampshade system comprising a first and second lampshade each comprising a shade member, a lamp support bracket, and first and second attachment means comprising one or more of a magnet, hook and loop fasteners, releasable clamps, adhesive portions, and threaded fasteners, the first attachment means located at a first position on the first lampshade arranged for releasably attaching the second lampshade or the lamp support bracket, the second attachment means located at a second position on the first lampshade arranged for releasably attaching a third lampshade or the lamp support bracket, such that, in use, the first and second lampshades are connectable together, in a user-defined arrangement for attachment to a light apparatus, wherein the lamp support bracket comprises at least one arm for supporting the lampshade thereon, the lamp support bracket being arranged such that a first portion of the arm is moveable relative to a second portion of the arm in a rotational, translational, and/or telescopic manner, in order to adjust the size of the at least one arm.

15. The modular lampshade system of claim 14, further comprising a first and second cover each having cover rim attachment means comprising one or more of a magnet, hook and loop fasteners, releasable clamps, adhesive portions, and threaded fasteners, wherein the rims of the first and second lampshades are circular, and the rim of the first lampshade has a larger diameter than the rim of the second lampshade, wherein the first cover rim has the same diameter as the rim of the first lampshade, and the second cover rim has the same diameter as the rim of the second lampshade, the modular lampshade system being arrangeable such that the first cover rim attachment means is attachable to the first attachment means of the first lampshade and the second cover rim attachment means is attachable to the second attachment means of the second lampshade to form a single lampshade.
